(19) United States
(12) Patent Application Publication
(10) Pub. No.: US 2002/0109725 A1
(43) Pub. Date: Aug. 15, 2002

(54) Control apparatus and control method for starting application software on a computer, and multi-monitor computer, client-server system, and storage medium using the same

(75) Inventors: Kei Suzuki, Shibuya-ku (JP); Hideki Kurashige, Shibuya-ku (JP); Daisuke Tabuchi, Shibuya-ku (JP); Katsunori Kuwajima, Shibuya-ku (JP)

Correspondence Address: OLIFF & BERRIDGE, PLC, P.O. BOX 19928, ALEXANDRIA, VA, 22320, US

(73) Assignee: Dream Technologies Corporation

(21) Appl. No.: 09/733,935

(22) Filed: Dec. 12, 2000

(30) Foreign Application Priority Data
Jan. 21, 2000 (JP) 2000-013184

(51) Int. Cl. G09G 5/00

(52) U.S. Cl. 345/769; 345/778

(57) ABSTRACT

The invention provides a control apparatus for starting application software on a computer, which can consolidate a variety of application interfaces and address a user's needs. The control apparatus includes an application start portion for starting one or more specified applications, an application registration portion for registering information relating to started applications as one group, an application start information storage portion for storing information for starting a registered application, and an application group start portion for searching the application start information storage portion based on an entered symbol and starting one or more corresponding applications. Usually, applications are started and terminated through an operating system, but with the present invention, they are started and terminated through a control window.

### BACKGROUND OF THE INVENTION

1. Field of the Invention

The present invention relates to a control apparatus and a control method for starting application software on a computer, and to a medium storing a program for the same.

2. Description of the Related Art

As the necessary software for operating computers, there is the so-called basic software (operating system) and the application software running on the operating system. Typical application software includes word processing software, spread sheet software and database software. These applications are extremely advantageous for making the operation of a business more effective, and many companies use many varieties of application software. These applications are managed by the operating system, they are started via the operating system, and input and output processing is carried out via the operating system.

Let us consider a situation, in which the user lets the computer perform a certain process. First of all the user turns on the power of the computer, so that the computer is ready to use. The operating system is started automatically. Then, the appropriate applications for performing the desired process are started with the operating system. For example, if the desired process is to create a document, then a word processing application is started, and if the desired process is accounting, then a spreadsheet application is started. Then, the files containing the specific data that are necessary for the process are opened, and the data can be revised or new data can be added.

As becomes clear from this procedure, in conventional computer systems, the user must first decide which application is suitable for performing the desired task, and then must start the corresponding application. Furthermore, after the application has been started, the files containing the relevant data must be opened with the application, before revising or adding data. In other words, the user has to perform a series of operations, so that the user has to learn and understand how to turn on the computer, how to start the applications and how to operate the applications In recent years the operatability of computer systems has improved vastly, and computer systems have come to be used by many people, but a lot of time still has to be invested into training for computer operation, and in the present situation, computer systems cannot be used freely by anyone. Such problems exist, because conventional computer systems are designed from the stand-point of the parties providing the system and the applications, and they are not designed to accustom the user's needs in the true meaning of the word. For example, user interface and operating method vary from application to application, which certainly does not address the user's needs.

A system that addresses the user's needs is one that can provide the environment desired by the user without going through complicated operations For example, the needs of someone managing a business is immediate access to the previous day's sales, the sales ranking broken down to individual stores, and the information about the top-ranking store, and the problem is not which applications to use for obtaining this information. For example, it is desirable that the necessary information is presented instantly simply by entering “Yesterdayrs Sale's”. However, with a conventional computer system, to access the sales, one has to perform the procedure of starting the database software, extracting the sales of the previous day, adding them up in the spreadsheet software, and displaying the data about the top-ranking store with the word processing software. The reason why such a troublesome procedure has to be applied is that the applications are established independently from one another, and the interfaces to the applications are separate. It would be desirable to consolidate them, but in reality, this is impossible. Therefore, to address the user's needs, a new means for consolidating the interfaces of the applications has to be devised.

In recent years, so-called ERP (Enterprise Resource Planning), that is, computer software for systematically organizing the administration and operating resources of an entire company, has come into use. ERP is used to organize company-wide fundamental operations like finance, accounting, sales, procurement, production management, inventory control, etc., which are performed by white collar workers. Features of ERP software are that it comes in off-the-shelf packages, includes several software components, widely covers fundamental operations, and data are automatically exchanged among related software components alongside the operation flow, which obviates the task of moving the data around. When ERP is introduced for operations covered in duplication by each section and each staff member of a business, this results in futile labor, and even though there is the potential to reduce the number of managerial tasks by 20 to 40%, ERP is definitely not an easy to use software, and for someone managing a business it is not easy to obtain desired information in an easy manner. Customizing a system to make it easy to obtain desired information incurs tremendous costs. Among people using administrative information, there is a great demand for apparatuses/software, with which ERP can be easily customized.

### SUMMARY OF THE INVENTION

It is an object of the present invention to solve these problems, and to provide a control apparatus and a control method for starting application software on a computer, as well as a medium storing a program for the same, with which a variety of application interfaces can be consolidated, and with which the user's needs can be addressed.

To achieve these objects, a control apparatus for starting application software on a computer in accordance with the present invention comprises:

an application start portion for starting one or more specified applications;

an application registration portion for registering information relating to started applications as one group;

an application start information storage portion storing information for starting a registered application; and

an application group start portion for searching the application start information storage portion based on an entered symbol and starting one or more corresponding applications.

A control method for starting application software on a computer in accordance with the present invention comprises:

an application start step for starting one or more specified applications;

an application registration step for registering information relating to started applications as one group;

an application start information storage step storing information for starting a registered application; and

an application group start step for searching application start information that has been stored based on an entered symbol and starting one or more corresponding applications.

A multi-monitor computer in accordance with the present invention comprises:

a processing portion;

a graphics memory for a plurality of screens that is controlled by the processing portion;

a plurality of display portions for displaying content of the graphics memory;

a control screen display portion for displaying a control screen;

an application start portion for starting one or more specified applications;

an application registration portion for registering information relating to started applications as one group;

an application start information storage portion storing information for starting a registered application; and

an application group start portion for searching the application start information storage portion based on an entered symbol and starting one or more corresponding applications; and

an application display portion for displaying started applications;

wherein the control screen display portion displays the control screen on one display portion; and

the application display portion displays the started applications on the other display portions.

A client-server system in accordance with the present invention comprises:

a plurality of clients; and

a server comprising:

an application start portion for starting one or more specified applications;

an application registration portion for registering information relating to started applications as one group;

an application start information storage portion storing information for starting a registered application; and

an application group start portion for searching the application start information storage portion based on an entered symbol and starting one or more corresponding applications;

wherein the clients send symbols to the server, and request data of started applications.

A storage medium in accordance with the present invention is for storing a program to have a computer execute:

an application start step for starting one or more specified applications;

an application registration step for registering information relating to started applications as one group;

an application start information storage step storing information for starting a registered application; and

an application group start step for searching application start information that has been stored based on an entered symbol and starting one or more corresponding applications.

Such a storage medium can be, for example, a floppy disk, a hard disk a magnetic tape, an optomagnetic disk, a CD-ROM, a DVD, a ROM cartridge, a RAM memory cartridge with battery backup, a flash memory cartridge or a non-volatile RAM cartridge.

It can also be a hardwired communication medium, such as a telephone line, a wireless communication medium, such as a microwave circuit, or any other communication medium. Also the Internet is such a communication medium.

“Medium” means something that stores information (mainly digital data and programs) by some physical means, and causes a processing device, such as a computer or a dedicated processor to carry out predetermined functions. That is to say, it is also possible to download a program by some means to a computer to execute predetermined functions.

### BRIEF DESCRIPTION OF THE DRAWINGS

FIG. 1 is a functional block diagram of an apparatus in accordance with Embodiment 1 of the present invention.

FIG. 2 is a diagram illustrating the registration of an application with an apparatus in accordance with Embodiment 1 of the present invention.

FIG. 3 is a diagram illustrating the start of a registered application with an apparatus in accordance with Embodiment 1 of the present invention.

FIG. 4 is an example of a display screen in accordance with Embodiment 1 of the present invention.

FIG. 5 is a diagram illustrating a window handle obtaining procedure according to Embodiment 1 of the present invention.

FIG. 6 is a diagram illustrating another window handle obtaining procedure according to Embodiment 1 of the present invention.

FIG. 7 is a diagram illustrating a window handle obtaining procedure according to Embodiment 1 of the present invention (combining the two procedures).

FIG. 8 is a diagram illustrating Embodiment 2 of the present invention.

FIG. 9 is an example of a display screen in accordance with Embodiment 2 of the present invention.

FIG. 10 shows a client-server system in accordance with Embodiment 3 of the present invention.

### DESCRIPTION OF THE PREFERRED EMBODIMENTS

Embodiment 1

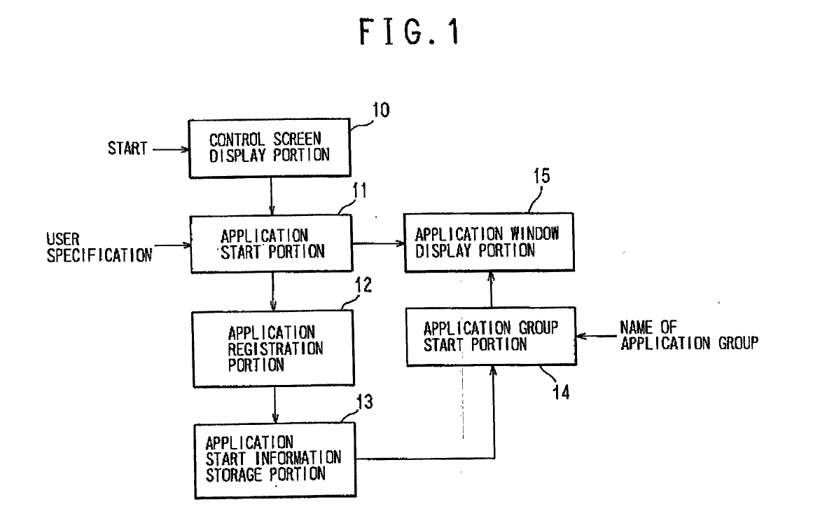

FIG. 1 is a functional block diagram of an apparatus in accordance with Embodiment 1 of the present invention. This apparatus is usually configured by setting up a program for configuring the apparatus on a computer such as a personal computer or a work station. A typical computer comprises a CPU, a memory, an external storage device, a keyboard, a mouse, a display portion and a communication device, like a modem, but these are not shown in FIG. 1. FIG. 1 shows the configuration that is functionally realized by the program, and does not show the hardware configuration itself.

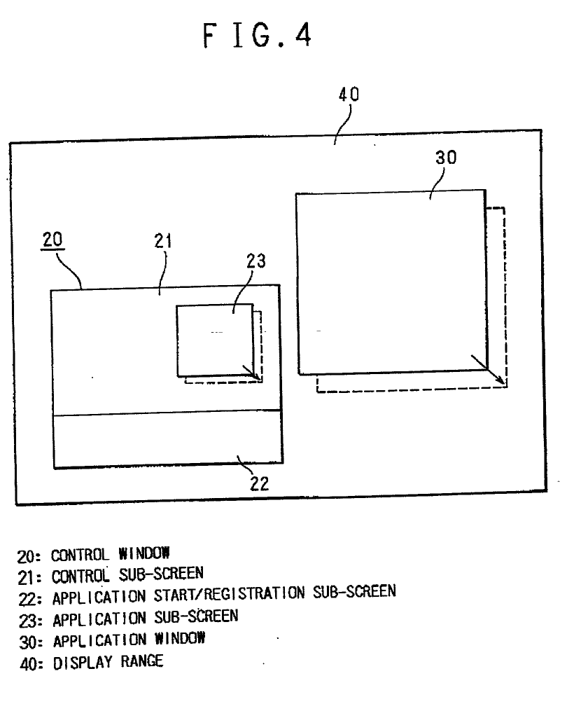

In FIG. 1, numeral 10 denotes a control screen display portion, which receives a start command by a user, and displays a control screen in accordance with the apparatus of the embodiment of the present invention. FIG. 4 illustrates an example of the control screen. Numeral 11 denotes an application start portion 11, which starts the application specified by the user. Numeral 12 denotes an application registration portion, which stores one or more started applications in an application start information storage portion 13. More specifically, information relating to the types of applications opened, files opened in these application is stored in the application start information storage portion 13, position and size of windows in these applications, and links to other applications. This information is arranged in one group, which is given a name, and the information relating to one or more applications can be referenced by specifying a name. Consequently, it is possible to start one or more applications by specifying a name. An application start portion 14 serves that purpose, and when it receives a name, it starts the group of applications corresponding to this name. Here, “group of applications” means one or more applications that have been registered by the application registration portion 12. The application start portion 14 looks up the group of applications in the application start information storage portion 13 taking the entered name as the key, references the corresponding information, and starts the application(s). A device/method for look-up taking an entered name as the key will be described below. Here, the applications displayed by an application window display portion 15 are the same as or equivalent to the applications registered by the application registration portion 12.

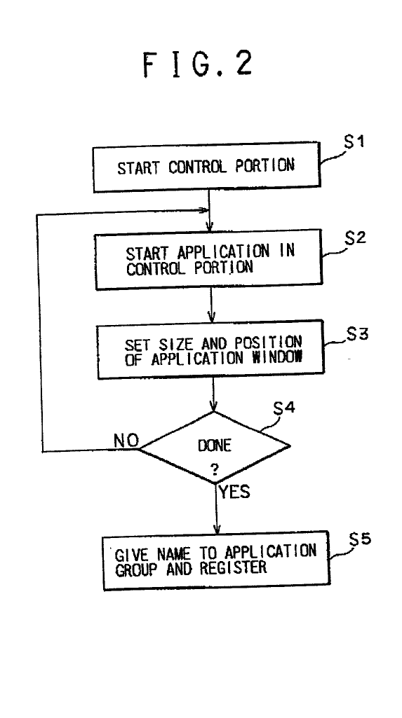

As can be seen from FIG. 1, the apparatus of Embodiment 1 of the present invention performs two processes, namely the registration of applications and the start of applications. Referring to FIG. 2, the following is an explanation of the process for the registration of applications.

In FIG. 2, first of all a control portion is started (S1) Then, a window 20 according to the apparatus of Embodiment 1 of the present invention is displayed. This window 20 has a control sub-screen 21 displaying the entire display range 40, and an application start screen 22 for starting applications and registering them with names. The control sub-screen 21 is for visualizing the position of the application window 30 within the display range 40 (which corresponds to the entire screen that is displayed by the display device) with the apparatus of Embodiment 1 of the present invention.

Then, an application is started in the window 20 of the control portion (S2). This can be any application, such as word-processing software, spreadsheet software, database software, groupware, map software, or ERP (Enterprise Resource Planning—computer software for systematically organizing the administration and operating resources of an entire company). There is no limitation to the number of applications that can be started. Within the bounds tolerated by the hardware resources, it is possible to start a plurality of applications. When an application is started, an application window 30 of a predetermined size is displayed at a predetermined position in the display range 40, as in the usual case. At the same time, an application sub-screen 23 is displayed in the control sub-screen 21.

Then, the size and/or the position of the application window 30 is set (S3). These settings can be carried out freely to accommodate the user's preferences. When the size and/or the position of the application window 30 is modified, then the size and/or the position of the application sub-screen 23 also changes accordingly. Conversely, also when the size and/or the position of the application sub-screen 23 is modified, the size and/or the position of the application window 30 changes as well. That is to say, the application window 30 and the application sub-screen 23 are associated with each other. In FIG. 4, this situation is indicated by the dotted line and the arrow. This is, because the control portion of Embodiment 1 of the present invention obtains the window information (window handle) of the application window 30. The application operates on (the window 20 of) this control portion, so that it can be managed with the control portion. Thus, the user can adjust the interface of the application freely, independently from the operating system.

When the settings for all applications have been finished, the procedure advances to Step S5, and if not, then the procedure returns to step S2, and the above sequence is repeated.

Then, a name is given to the application group of one or more applications displayed in the entire display range 40, and the application group is registered (S5).

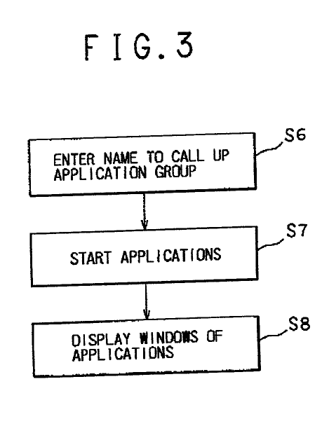

Referring to FIG. 3, the following is an explanation of the process for starting an application.

Entering the name that has been given in Step S5, the corresponding application group is called up (S6). More specifically, the information that the application start portion 14 reads out from the application start information storage potion 13 is the information relating to the types of applications corresponding to the name, the files to be opened in these application, position and size of windows in these applications, and links to other applications.

The applications are started taking the read-out information as the parameters (S7).

Then, the windows of the applications are displayed (S5).

These processes provide a system that can accommodate the user's needs. That is to say, once the registration has been performed, simply entering its name makes it possible to provide the environment desired by the user without requiring the user to perform a complicated operation. For example, a list that lists the sales of the previous day for each of a number of stores is created and displayed on the apparatus (window 20) of Embodiment 1 of the present invention with a spreadsheet program, the profile of the store with the highest sales is looked up from a database and displayed, and a daily report is created with a word processing and stored under the name “Yesterday's Sales” (see S2 to S5 in FIG. 2). After that, the corresponding windows can be opened and this information can be presented instantaneously simply by entering “Yesterday's Sales” in the apparatus (window 20) of Embodiment 1 of the present invention and performing the look-up. This is, because the necessary information for starting the applications is stored in the application start information storage portion 13 of the apparatus. The registration can be carried out in a relatively simple manner, and can be handled by a general user having only knowledge about the basic operation of applications. With this apparatus of Embodiment 1 of the present invention, the interface of applications can be consolidated to some degree, without requiring a lot of effort. On the other hand, in the related art, it is necessary to let a specialized engineer customize the software to achieve a similar purpose.

What makes this possible is the fact that the applications are controlled by the apparatus of Embodiment 1 of the present invention. Usually, applications are started and terminated by the operating system, but in Embodiment 1 of the present invention, they are started and terminated through the control window 20. Due to this difference, it is possible to achieve a certain consolidation of the user interface.

Further explanations follow, taking an example of applying the control portion of an embodiment of the present invention to the operating system of a regular personal computer.

When an application (that is, any program besides the control portion) is started with the control portion, first of all the application is started by dragging and dropping the data to be displayed into the control portion. Any method can be used for realizing the drag-and-drop operation. However, in the embodiments of the present invention, not the “executable file” but the “data” that the user wants to display is passed to the control portion, which is different from a regular personal computer operating system. It is important to keep this point in mind.

To simply “start an application and keep it running”, there is the API, with which data files are specified to the operating system to start the corresponding standard applications, so that the starting side does not have to know explicitly which application is to be started. However, the purpose of the control portion in the embodiments of the present invention is to control the started windows, so that to specify what windows have been started, it is necessary to determine some information about the application to be started before starting the application.

When a file is being dragged and dropped, the control portion according to an embodiment of the present invention automatically obtains the following information:

1. full path of the dropped file;

2. full path of the application to be started;

3. option switches that may have to be specified at start when passing data to the application to be started (for example: start options of the format /p /n or the like).

The control portion obtains this information mainly from the registry of the operating system. Moreover, if this information cannot be obtained from the registry, the operating system is queried which operating system should be started using the API of the operating system, and if the dropped file is for example an Internet shortcut, then this file is read directly to obtain the start information (1 to 3).

Besides data files (for example, files with the extensions .txt, .csv, or .bmp), it is also possible to drop shortcuts (extension .lnk) or Internet shortcut (extension .url) in the control portion. If a shortcut has been dropped, then the executable file, data file and option switches specified by the shortcut are obtained.

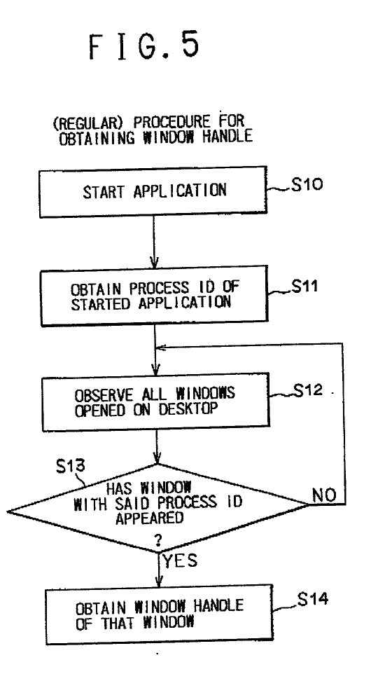

When this information is obtained, the start of the application is finally performed using the API of the operating system, and the application is started with the API, which returns the “process ID” assigned to the application that is being started. This is, because it is not possible to specify a started window simply by starting it (see S10 and S11 in FIG. 5).

It is necessary to clearly specify to the API information such as the executable file of the started application. Consequently, as mentioned above, it is necessary to obtain information about an application before starting it.

Thus based on the obtained process ID, the “window handle” that is necessary for controlling the started window is obtained by carrying out the following operation.

After starting the application, while continuing to enumerate and observe all windows opened on the operating system's desktop, the procedure waits until all windows having a preceding process ID have appeared on the desktop (S12 and S13 in FIG. 5). To cope with start failures, it is preferable to set a timeout.

Thus, when the window having the obtained process ID appears on the desktop, it becomes the started window. At this stage, it is possible to obtain the “window handle”, because the control portion itself enumerates the windows on the desktop and looks for the window of interest (S14 in FIG. 5).

It should be noted that is not possible to obtain the window handle before starting the application, because only one such ID is given to every “currently open window”.

Although only one ID is given to every “currently open window” usually an application is actually made up of several windows, even though it may look like only one window. Consequently, in units of “applications, a plurality of window handles can be given to one application. In such a case, among the plurality of windows, the window constituting what seems to be the outer frame is called the main frame, and only the window handle of this main frame is handled by the control portion.

When a window handle has been obtained in this manner, it is possible to obtain the following information about the started window:

position and size of the window

window caption (title character string)

etc.

On the other hand, specifying a window with its window handle and giving the above information, it is possible to change the position and the size of a currently open window. There are also situations when it is not possible to make modifications, but usually it is no problem to modify position and size. Usually, this control is performed with instructions of the operating system according to user operations.

With this method, it is basically possible to obtain the window handle of a started application, obtain position and size of this window and then control it, but there are exceptions.

An exception is that in this method, there is the portion “obtain process ID”, but this process ID is the “ID when only one ID is given to one process”, and as with the window handle, its (strict) meaning differs from the “ID given to a window”.

This can become a problem when the same application is started several times.

In regular applications, even if the same application is started several times, a number of processes is started that is equal to the number of times the application has been started, so that the process IDs correspond one-to-one to the window handles, and it is alright for a method to use these process IDs, but there are applications, in which from the second start on, no new process is created, which is supposed to make the start faster. Depending on the application, there are many possibilities how a window can be opened without creating a new process.

In this case, there is no one-to-one correspondence between the process IDs and the window handles. Moreover, since the process IDs that are actually returned by the API from the second start of the application on are invalid, the window of interest will never appear on the desktop when looking up the window on the desktop with this ID.

As a countermeasure, also the following method can be used with the control portion.

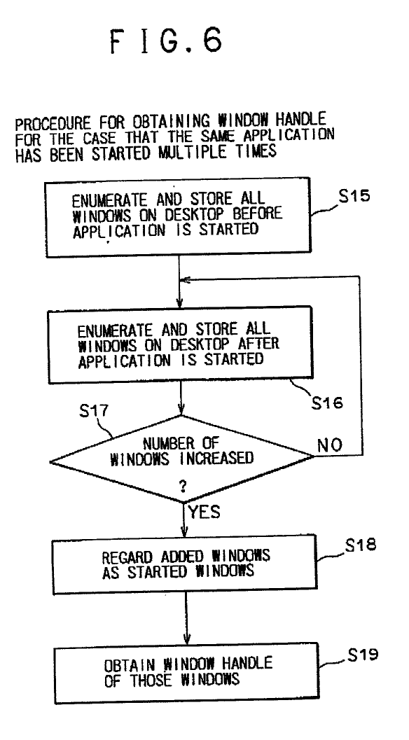

Before starting the application, all windows on the desktop are enumerated and stored (S15 in FIG. 6).

Then, after starting the application, when all windows on the desktop are enumerated again (S16 in FIG. 6), the number of windows enumerated after starting the application should be larger than the number of windows enumerated before starting the application.

That is to say, the newly added windows can be regarded as “started windows” (S18 in FIG. 6). Actually, the procedure waits while enumerating and observing all windows on the desktop until the number of windows has increased (S17 in FIG. 6).

With this method it becomes possible to obtain the window handle of an application that does not create a new process from its second start on (S19 in FIG. 6).

But on the other hand, there is also the possibility that the handle of an undesired window is obtained with an application that starts a plurality of processes at each start of the application. Moreover, the time for determining the window handles is longer than with the method using the process IDs.

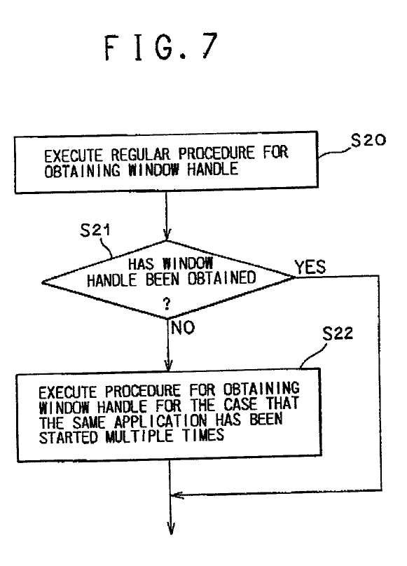

However, the control portion uses both the first method using the process IDs as well as this second method. Referring to them as “first method” and “second method”, the control portion first attempts to obtain the handles with the first method, and when it fails, it obtains the handles with the second method (S20 to S22 in FIG. 7).

Moreover, when starting a plurality of applications with the control portion, it is preferable that the applications are started one by one, and that the next window is always started after determining the handle of the started window, in order to avoid that it becomes unclear which window corresponds to which information, once a plurality of applications have been started.

By applying to this procedure, considering that a plurality of windows are started successively, as long as no exception occurs, the optimal procedure can be applied relatively fast (because the fast method is attempted first), and at the same time the overlooking of window handles can be kept to a minimum.

During the execution of an application, the control portion does not use the application information obtained at the time of registration as is, because, when the information registered by the control portion is shared by a plurality of clients, the application may vary from client to client, even though the data are the same. Thus, during the execution of an application, only the data files of the registered information are used for execution, whereas the application is looked up for each client with the above method (except when only an executable file has been specified).

Thus, when obtaining application information from a data file, it is necessary to consider the problems that can occur when opening a plurality of windows. At the registration, start is carried out by drag and drop, so that this does not lead to the opening of a plurality of applications at once, but at execution, this may well happen, if the appropriate precautions are not taken.

The following is a more specific explanation of an apparatus/method that performs look-up, taking the name that has been entered in Step S6 as the key, references the corresponding information, and starts the applications.

Such an apparatus comprises a symbol receiving portion and a conversion portion. The symbol receiving portion receives symbols, which have been specified by the user in the selected application, from a computer memory area that can be used for sending data from an application that has been selected by the user to a destination outside this application. The conversion portion converts the received symbols into location information indicating the location on the computer that has been associated with the received symbols, and designates locations to applications using this location information.

This apparatus is a system for designating locations such that the applications on a computer can use the locations of the computer resources.

The aforementioned symbols are objects that can be displayed by the man-machine interface of the computer, and they can be, for example, text data, vector graphics data, bit image data, sound data, files, folders, directories, paths, etc. Preferably, the symbols can be associated by the user with some meaning or concept. Typical examples of such symbols are words, phrases and sentences of a human language, and illustrative marks designed by humans. Also trademarks, service marks, business names, personal names, titles and ad slogans are suitable as symbols.

When the user specifies a symbol in a given application, the apparatus uses the location corresponding to the specified symbol for the application (for example, the above-mentioned control portion). Consequently, as long as the user knows the symbol, it is possible to access the resources corresponding to that symbol. This is a typical example of how company names, trade marks or personal names can be used as symbols, and how the corresponding applications can be started simply by specifying the right symbol.

A resident program called “linker” is installed in the computer. Moreover, the computer has a database, in which a large number symbols and the corresponding applications are linked to each other and stored. (Here, “link” is used in a different sense than a “link” or a “jump” that is produced in hypertext markup language, so care should be taken not to confuse them.)

Here, “symbol” means the data of a representation (symbol) that can be recognized by a human's five senses and remembered, which a human can be specify to a computer with the man-machine interface of the computer. The most typical example of a symbol is the text data of characters and signs that are ordinarily handled by applications such as desktop publishing (referred to as “DTP” in the following) programs and spreadsheets, such as words, expressions, phrases, sentences, texts, and other data. Symbols are not limited to text data, and symbols can also be vector graphics data as used by “Draw”-type graphics applications, or bitmap data used by “Paint”-type graphics applications. Moreover, symbols can also be three-dimensional graphics data representing 3D images as used by 3D graphics applications. Furthermore, there is no limitation to representations that can be recognized by the visual sense, and representations that can be recognized by the auditory sense, such as the data of melodies or rhythms can also be symbols. It is preferable that a symbol represents some kind of meaning or concept. Something that does not remind a human being of some meaning or concept, like a random numerical string, is not appropriate as a symbol. On the other hand, words, expressions, phrases, sentences, texts, trademarks, service marks, ad slogans, company names, personal names and names in general are suitable as symbols. Geographical names, addresses and telephone numbers are also appropriate as symbols.

The computer user can specify a desired symbol to the linker. Taking the specified symbols as the search key (that is, the object, such as a word, for which to search), the linkers in the computer look up the applications corresponding to the symbols in a database. Then, the linkers in the computer start the corresponding application.

With this operation, the user of the computer can open the necessary applications by specifying a symbol. Thus, it is sufficient if the user knows the symbol of a page to be opened, and the user does not have to know any further detailed information. It is possible to set the symbols to text or graphics, which can be easily perceived by a human.

Embodiment 2

The above-described Embodiment 1 relates to an example using a regular computer with one display portion. The present invention can also be applied to multi-monitor computers provided with a plurality of display portions. In that case, the advantages of the present invention come even better to play.

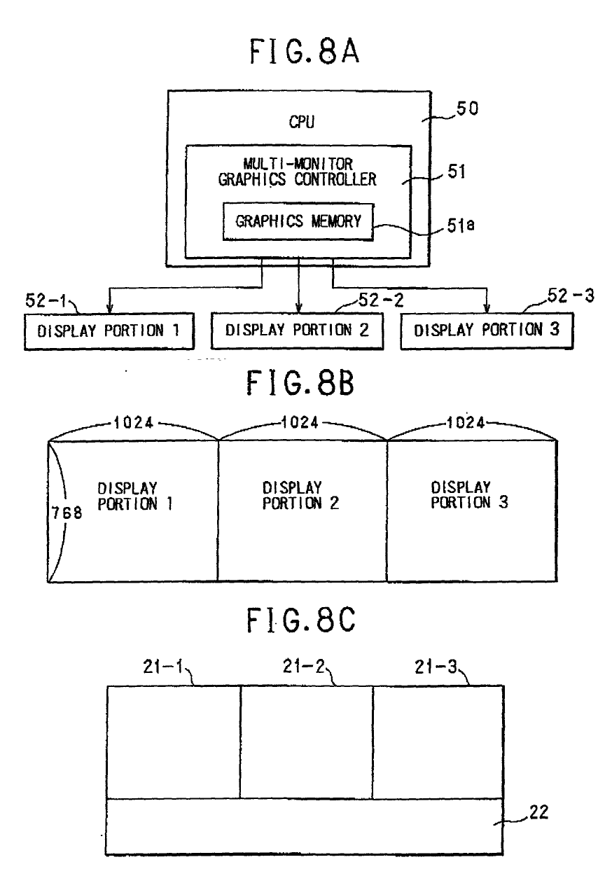

FIG. 8a shows a multi-monitor computer with three display portions connected to it. A CPU 50 is provided with a multi-monitor graphics controller 51, to which three display portions 1, 2 and 3 (52-1, 52-2 and 52-3) are connected. As shown in FIG. 8b, a graphic memory 51a of the multi-monitor graphics controller 51 has a larger capacity than a regular memory. That is to say, a pixel image of 3072 dots (horizontal) by 768 dots (vertical), which is three times larger than usual, can be displayed. The graphic memory 51a is allocated to the display portions 1 to 3, as shown in FIG. 8b. It is possible to display windows at any position on these screens, and to move the displayed windows to any position. The multi-monitor computer has a display area that is larger than that of a regular personal computer, and is convenient in that a large number of windows can be displayed without overlapping.

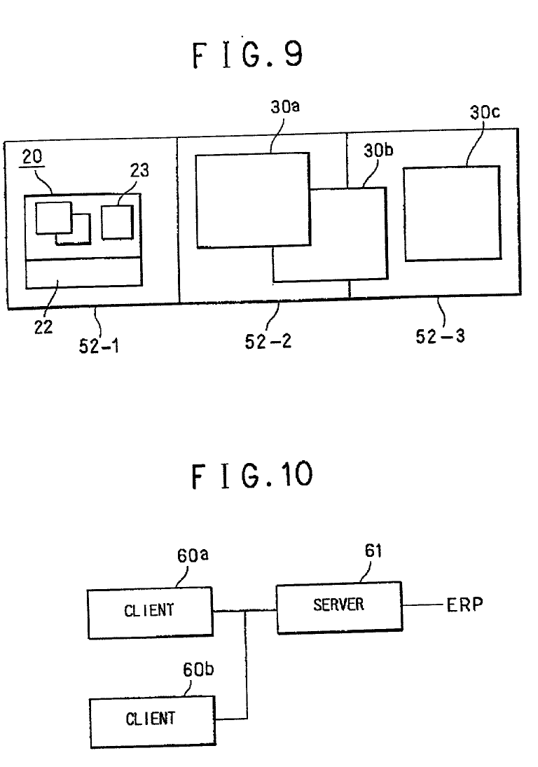

If the apparatus of the present invention is applied to a multi-monitor computer, then it is preferable that the window 20 of the control portion is displayed in one of the plurality of screens, and the windows started by the control portion are opened in the other screens. For example, the window 20 of the control portion is displayed in the display portion 52-1, the application window 30a is displayed in the display portion 52-2, the application window 30c is displayed in the display portion 52-3, and the application window 30b is displayed between the display portions 52-2 and 52-3, as shown in FIG. 9. Such a configuration is possible with the control portion of the present invention. Since the display area of a multi-monitor computer is larger, a plurality of application windows can be displayed without overlapping, which is convenient for obtaining a lot of information at once. Furthermore, using one of the monitors for control, it is easy to register and start applications.

The following is an example of a specific application. The display portion 52-1, which displays the window of the control portion, is placed on the desk of the person operating the control portion in accordance with the present invention (such as an executive's secretary), and the display portions 52-2 and 52-3, which display the applications, are placed on the desk of the executive. When demanded by the executive, the secretary can enter the words “Yesterday's Sales”, “This Month's Sales”, “Sales Ranking” etc., and operate the control portion in accordance with the present invention to start the registered applications. The secretary can view a control screen for that purpose, but the executive cannot. With this configuration, the executive can view all information necessary to her/him, without being exposed to any hassles. Thus, one multi-monitor personal computer is set up, one monitor is arranged to be operated by an operator, other monitors are setup for the user for information access, the control portion in accordance with the present invention is displayed on the monitor of the operator, and the application windows are displayed on the other monitors, which makes the operation easy and provides an easy-to-use information access system. Another possible application is, for example, to use large screens, such as projectors, as the display portions 52-2 and 52-3 as display screens for presentations, and to use a liquid crystal display screen as the control portion 52-1 for control.

Embodiment 3

A control portion according to this aspect of the present invention can be applied not only to a stand-alone computer, but also to a client-server system. For example, in the system shown in FIG. 10, in which a plurality of clients 60a and 60b are connected to a server 61, the server is provided with a control portion in accordance with the present invention. The server 61 can obtain the necessary data from ERP software. In this case, the client 60a requests the server 61 to start the control portion in accordance with the present invention and the control portion of the server 61 starts previously registered applications and sends the data to the client 60a. At any client, the necessary information can be accessed simply by entering, for example, “Yesterday's Sales”. Although the server 61 receives the files including the necessary data from the ERP software to display them, the display interface of the ERP software is not modified. Consequently, the client can display the information with the desired interface, without having to pay attention to the interface of the ERP software. Moreover, the client can include a dedicated ERP viewer if necessary. By including a dedicated viewer, it is also possible to revise the data.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

Furthermore, in this specification, “means” does not necessarily refer to a physical means, and the function of such means embraces all cases that can be realized by software. Moreover, the function of one means can also be realized by two or more physical means, and the function of two or more means can also be realized by only one physical means.

What is claimed is:

1. A control apparatus for starting application software on a computer, comprising:
an application start portion for starting one or more specified applications;
an application registration portion for registering information relating to started applications as one group;
an application start information storage portion for storing information for starting a registered application; and
an application group start portion for searching the application start information storage portion based on an entered symbol and starting one or more corresponding applications.

2. The control apparatus for starting application software on a computer according to claim 1, further comprising:
a symbol receiving portion for receiving a symbol that has been specified arbitrarily by a user;
a conversion portion for converting the received symbol into location information indicating resources on the computer that have been previously associated with the symbol; and
a designation portion that designates locations to applications using this location information;
wherein the application start information storage portion is searched by designation of the designation portion.

3. The control apparatus for starting application software on a computer according to claim 2, wherein the symbol is entered via a clipboard.

4. The control apparatus for starting application software on a computer according to claim 2, further comprising:
a buffer; and
a character conversion portion, which, when receiving characters entered by a user with a key input device and temporarily holding the characters in the buffer, transfers the characters held in the buffer to a specified application while carrying out a conversion if necessary and not carrying out a conversion if not necessary;
wherein the symbol is entered via the buffer of the conversion portion.

5. The control apparatus for starting application software on a computer according to claim 1, wherein, when a file is dragged and dropped, the application registration portion obtains at least a full path of the dropped file, a full path of the application to be started, and option switches that may have to be specified when passing data to the application to be started and starting the application.

6. The control apparatus for starting application software on a computer according to claim 1,
wherein the application group start portion comprises a window handle obtaining portion, which obtains a process ID of a started application, observes whether a window having this process ID has appeared, and, when such a window has appeared, obtains a window handle of that window; and
wherein the window of that application is controlled on the basis of the window handle.

7. The control apparatus for starting application software on a computer according to claim 1,
wherein the application group start portion comprises a second window handle obtaining portion, which enumerates and stores all windows on the desktop before starting an application, enumerates all windows on the desktop after starting an application, and, when, comparing the two, the number of windows has increased, obtains the window handles of the started windows, regarding the added windows as the started windows; and
wherein the windows of those applications are controlled on the basis of the window handles.

8. A control method for starting application software on a computer, comprising:
an application start step for starting one or more specified applications;
an application registration step of registering information relating to started applications as one group;
an application start information storage step of storing information for starting a registered application; and
an application group start step of searching application start information that has been stored based on an entered symbol and starting one or more corresponding applications.

9. A control method for starting application software on a computer, comprising:
a step of activating a control portion and displaying a control sub-screen and an application start screen;
a step of starting an application software in a window of the control portion and displaying an application screen of a predetermined size, and displaying an application sub-screen in the control sub-screen;
a step of, when a user has set the size and/or the position of the application screen, modifying the size and/or the position of the application sub-screen in response thereto;
a step of giving a name to an application group composed of one or more applications that are displayed in the entire display range and registering that application group;
a step of entering the name to call up a corresponding application group;
a step of starting applications, taking the information that has been read out as parameters; and
a step of displaying windows of the applications.

10. The control method for starting application software on a computer according to claim 9, wherein the control sub-screen is a screen for visualizing the position of application windows in the display range corresponding to an entire screen displayed by a display device.

11. The control method for starting application software on a computer according to claim 9, further comprising a step of modifying the size and/or the position of the application screen performed in response when the user has changed the size and/or the position of the application sub-screen.

12. The control method for starting application software on a computer according to claim 9, wherein the step of calling up a corresponding application group reads at least one of the group consisting of the type of application corresponding to the name, the file to be opened by that application, the position and the size of a window of the application, and information relating to links to other applications.

13. The control method for starting application software on a computer according to claim 9, further comprising a step in which the control portion obtains window information including the window handle of the application screen so as to associate the application screen and the application sub-screen.

14. The control method for starting application software on a computer according to claim 13, wherein the step of obtaining window information comprises:
a step of obtaining a process ID of a started application when an application software has been started;
a step of observing all windows opened in all screens;
a step of determining whether a window with said process ID has appeared; and
a step of obtaining the window handle of that window when the window with said process ID has appeared.

15. The control method for starting application software on a computer according to claim 14, wherein processing of the step of determining whether a window with said process ID has appeared is interrupted when said window has not appeared after a predetermined time.

16. The control method for starting application software on a computer according to claim 13, wherein the step of obtaining window information comprises:
a step of storing all windows in all screens before starting an application software;
a step of enumerating all windows in all screens after starting an application software;
a step of determining whether the number of windows has increased;
a step of regarding added windows as started windows; and
a step of obtaining the window handles of those windows.

17. The control method for starting application software on a computer according to claim 13, wherein the step of obtaining window information comprises:
a step of obtaining a process ID of a started application when an application software has been started;
a step of observing all windows opened in all screens;
a step of determining whether a window with said process ID has appeared;
a step of obtaining the window handle of that window when the window with said process ID has appeared;
a step of terminating the process when the window handle could be obtained in the preceding step;
a step of storing all windows in all screens before starting an application software;
a step of enumerating all windows in all screens after starting an application software;
a step of determining whether the number of windows has increased;
a step of regarding added windows as started windows; and
a step of obtaining the window handles of those windows.

18. The control method for starting application software on a computer according to claim 13, wherein the step of entering a name to call up a corresponding application group comprises;
a step of receiving a symbol, which has been arbitrarily specified by the user in a selected application, from a computer memory area that can be used for sending data from an application that has been arbitrarily selected by the user to a destination outside this application; and
a step of converting a received symbol into location information indicating the location on the computer that has been associated with the received symbol, and designating a location to the application using this location information.

19. A medium for storing a program to have a computer execute:
an application start step for starting one or more specified applications;
an application registration step for registering information relating to started applications as one group;
an application start information storage step storing information for starting a registered application; and
an application group start step for searching application start information that has been stored based on an entered symbol and starting one or more corresponding applications.

20. A multi-monitor computer comprising:
a processing portion;
a graphics memory for a plurality of screens that is controlled by the processing portion;
a plurality of display portions for displaying content of the graphics memory;
a control screen display portion for displaying a control screen;
an application start portion for starting one or more specified applications;
an application registration portion for registering information relating to started applications as one group;
an application start information storage portion for storing information for starting a registered application; and
an application group start portion for searching the application start in formation storage portion based on an entered symbol and starting one or more corresponding applications; and
an application display portion for displaying started applications;
wherein the control screen display portion displays the control screen on one display portion; and
wherein the application display portion displays the started applications on the other display portions.

21. The multi-monitor computer according to claim 20,
wherein the display portion on which the control screen is displayed is a small display device for operation; and
wherein the display portion for displaying applications is a large display device for presentation.

22. A client-server system comprising a plurality of clients and a server,
wherein the server comprises:
an application start portion for starting one or more specified applications;
an application registration portion for registering information relating to started applications as one group;
an application start information storage portion storing information for starting a registered application; and
an application group start portion for searching the application start information storage portion based on an entered symbol and starting one or more corresponding applications; and
wherein the clients send symbols to the server, and request data of started applications.
